(19) United States
(12) Patent Application Publication
(10) Pub. No.: US 2021/0095976 A1
(43) Pub. Date: Apr. 1, 2021

(54) METHOD AND SYSTEM FOR ADAPTIVE NAVIGATION OF AUTONOMOUS VEHICLES

(71) Applicant: Wipro Limited, Bangalore (IN)

(72) Inventors: Manas Sarkar, Barasat (IN); Balaji Sunil Kumar, Bangalore (IN)

(21) Appl. No.: 16/694,652

(22) Filed: Nov. 25, 2019

(30) Foreign Application Priority Data
Sep. 30, 2019 (IN) 201941039587

(51) Int. Cl. G01C 21/34

(52) U.S. Cl. CPC G01C 21/3415; G01C 21/3453

(57) ABSTRACT

Embodiments of the present disclosure relate to a method and an autonomous navigation system for adaptively navigating an Autonomous Vehicle (AV). The autonomous navigation system obtains a global path comprising a plurality of global waypoints. The global path is generated from a source location to a destination location for the AV to navigate along the global path. A location of the AV is determined where an orientation of the AV deviates from an orientation of the global path. One or more global waypoints are identified, and a global waypoint is selected as reference. Further, proximal to the selected global waypoint, a first set of local waypoints are generated, and a first set of paths are generated from the AV to the first set of local waypoints. A local path is selected based on a cost factor for the AV to navigate along the selected local path.

This application claims the benefit of Indian Patent Application Serial No. 201941039587 filed Sep. 30, 2019, which is hereby incorporated by reference in its entirety.

### FIELD

The present disclosure relates to automobile industry. More particularly, but not specifically, the present disclosure relates to adaptive navigation of autonomous vehicles

### BACKGROUND

An autonomous vehicle (driverless vehicle) uses various sensors to navigate through a path. Various techniques are used to detect obstacles in the surroundings of the vehicle while navigating the vehicle in the path. Generally, the autonomous vehicle has a main control unit that helps the autonomous vehicle to traverse a path to reach a destination location from a source location. Generally, a global path is generated to traverse the autonomous vehicle from the source location to the destination location. Also, the main control unit detects any obstacles and maneuvers the obstacles by traversing the vehicle in an alternate path.

Generally, the autonomous vehicle is configured to follow the global path. However, the global path does not indicate intricate details for maneuvering, such as avoiding obstacles, turning within a lane, and the like. Different techniques are used for maneuvering such instances. For example, while overtaking a vehicle, the autonomous vehicle deviates from the global path, overtakes the vehicle and joins the global path. During such maneuvering, the autonomous vehicle can take various short paths (local paths), thereafter, the autonomous vehicle joins the global path. Often, while the autonomous vehicle joins the global path from the local path, the autonomous vehicle may not have a smooth transition. In some instances, steep turning angles can cause discomfort to passengers in the autonomous vehicles. In some instances where turning radius is less, the autonomous vehicle is repeatedly steered forward and backward to navigate via the global path. Hence, existing autonomous navigation systems do not provide a smooth navigation over the global path.

The information disclosed in this background of the disclosure section is only for enhancement of understanding of the general background of the invention and should not be taken as an acknowledgment or any form of suggestion that this information forms the prior art already known to a person skilled in the art.

### SUMMARY

In an embodiment, a method for adaptive navigation of an Autonomous Vehicle (AV) is disclosed. The method comprises obtaining, by an autonomous navigation system, a global path from a source location to a destination location for the AV, where the global path comprises a plurality of global waypoints. The method further comprises determining a current location of the AV where an orientation of the AV is deviating from an orientation of the global path by a threshold angle. Further, identifying one or more global waypoints from the plurality of global waypoints. Thereafter, the method comprises generating a first set of local waypoints proximal to a global waypoint from the one or more global waypoints based on the current orientation of the AV, a velocity of the AV and the orientation of the global path. Furthermore, the method comprises generating a first set of local paths from the current location of the AV to the first set of local waypoints. The AV is configured to navigate along the first set of local paths proximate to the global path. Further, the method comprises selecting a local path from the first set of local paths based on a cost factor, for adaptively navigating the AV along the local path.

In an embodiment, an autonomous navigation system for adaptive navigating an Autonomous Vehicle (AV) is disclosed. The autonomous navigation system comprises one or more processors and one or more memories. The one or more processors are configured to obtain a global path from a source location to a destination location for the AV, where the global path comprises a plurality of global waypoints. The one or more processors further determine a current location of the AV where an orientation of the AV is deviating from an orientation of the global path by a threshold angle. Thereafter, the one or more processors identify one or more global waypoints from the plurality of global waypoints, generate a first set of local waypoints proximal to a global waypoint from the one or more global waypoints based on the current orientation of the AV, a velocity of the AV and the orientation of the global path. Furthermore, the one or more processors generate a first set of local paths from the current location of the AV to the first set of local waypoints, where the AV is configured to navigate along the first set of local paths proximate to the global path. Further, the one or more processors select a local path from the first set of local paths based on a cost factor, for adaptively navigating the AV along the local path.

In an embodiment, a non-transitory computer readable medium including instructions stored thereon that when processed by at least one processor cause a device to perform operations is disclosed. The non-transitory computer readable medium comprises obtaining, by an autonomous navigation system, a global path from a source location to a destination location for the AV, where the global path comprises a plurality of global waypoints. The non-transitory computer readable medium further comprises determining a current location of the AV where an orientation of the AV is deviating from an orientation of the global path by a threshold angle. Further, identifying one or more global waypoints from the plurality of global waypoints. Thereafter, the non-transitory computer readable medium comprises generating a first set of local waypoints proximal to a global waypoint from the one or more global waypoints based on the current orientation of the AV, a velocity of the AV and the orientation of the global path. Furthermore, the non-transitory computer readable medium comprises generating a first set of local paths from the current location of the AV to the first set of local waypoints. The AV is configured to navigate along the first set of local paths proximate to the global path. Further, the non-transitory computer readable medium comprises selecting a local path from the first set of local paths based on a cost factor, for adaptively navigating the AV along the local path.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 is illustrative of an exemplary block diagram of an autonomous navigation system for adaptively navigating an autonomous vehicle, in accordance with some embodiments of the present disclosure;

FIG. 2 is a block diagram of internal architecture of an ECU configured to adaptively navigate an autonomous vehicle, in accordance with some embodiments of the present disclosure;

FIG. 3 is illustrative of exemplary method steps for adaptively navigate an autonomous vehicle, in accordance with some embodiments of the present disclosure;

FIG. 4 shows an exemplary illustration of a global path for autonomous vehicle navigation, in accordance with some embodiments of the present disclosure;

FIG. 5A is an exemplary illustration of selecting a global waypoint among a plurality of global waypoints, in accordance with some embodiments of the present disclosure;

FIG. 5B is an exemplary illustration of a waypoint as a vector, in accordance with some embodiments of the present disclosure;

FIG. 6 is an exemplary illustration of generating a first set of local waypoints, in accordance with some embodiments of the present disclosure;

FIG. 7 is an exemplary illustration of generating a second set of local waypoints, in accordance with some embodiments of the present disclosure;

FIG. 8 is an exemplary illustration of hierarchy of adaptive path navigation , in accordance with some embodiments of the present disclosure; and

FIG. 9 is an exemplary illustration of generating a set of local paths, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a method and an autonomous navigation system for adaptively navigating an Autonomous Vehicle (AV). The autonomous navigation system obtains a global path comprising a plurality of global waypoints. The global path is generated from a source location to a destination location for the AV to navigate along the global path. A location of the AV is determined where an orientation of the AV deviates from an orientation of the global path. One or more global waypoints ahead of the AV from the determined location are identified and a global waypoint is selected as reference. Further, proximal to the selected global waypoint, a first set of local waypoints are generated, and a first set of paths are generated from the AV to the first set of local waypoints. A local path is selected based on a cost factor for the AV to navigate along the selected local path. The navigation along the selected local path provides a smooth navigation while avoiding obstacle, steep turning or changing lanes.

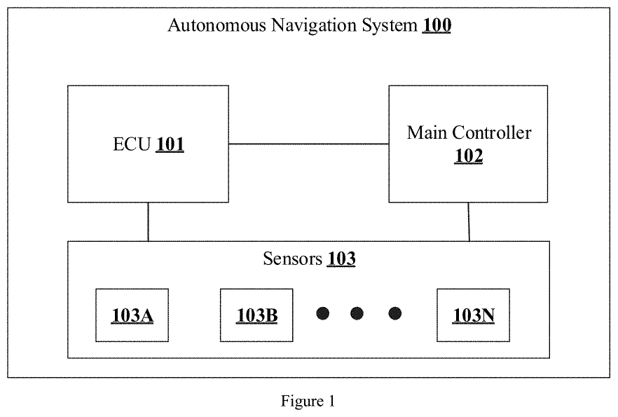

FIG. 1 shows an exemplary block diagram of an autonomous navigation system (100) for adaptively navigating an Autonomous Vehicle (AV), in accordance with some embodiments of the present disclosure. The autonomous navigation system (100) comprises an Electronic Control Unit (ECU) (101), a main controller (102), a sensor (103A), a sensor (103B), . . . , and a sensor (103N). In an embodiment, the sensor (103A), the sensor (103B), . . . the sensor (103N) may be collectively represented as one or more sensors (103) henceforth in the present disclosure. In an embodiment, the main controller (102) may be configured to autonomously navigating the AV in a forward/reverse path. In an embodiment, the ECU (101) may be used for autonomously navigating the AV adaptively. For example, the ECU (101) may be configured to navigate the AV while changing lanes on a road, while overtaking another vehicle, while turning in a path having a steep turning radius and the like. In an embodiment, the ECU (101) may be integrated with the main controller (102) or may be a standalone unit. The ECU (101) may receive information regarding an obstacle or curvature of the forward/reverse path from the main controller (102) or an indication to change lanes, when the vehicle is moving at a certain velocity. The ECU (101) may further receive information regarding forward/reverse steering angle form the main controller (102). The forward/reverse steering angle may be an angle calculated between an orientation of the vehicle and a direction of a global path. For example, the global path may be a path mapped by the main controller (102) to navigate the AV from a source location to a destination location. In an embodiment, the global path may be a straight path, a curved path or any other path connecting the source location to the destination location. The ECU (101) may receive the forward steering angle calculated by the main controller (102), at predefined intervals of time. Further, the ECU (101) may compare the forward steering angle with a predefined threshold value. If the forward steering angle is greater than the predefined threshold value, then the ECU (101) may instruct the main controller (102) to maneuver the AV to traverse the global path. If the forward steering angle is more than the predefined threshold value, then the ECU (101) may immediately instruct the main controller (102) to terminate steering the AV in the global path. The forward angle being more than the threshold value may indicate at least a presence of an obstacle in the global path, a steep turning radius or an indication from the AV to change lanes. Thus, the ECU (101) may generate one or more sets of local paths to maneuver the AV. In an embodiment, the one or more sets of local paths are generated by the ECU (101) such that the one or more sets of local paths are proximate to the global path. The one or more sets of local paths may be one or more short paths that deviate from the global path for a brief time period for at least one of avoiding obstacles, changing lanes, overtaking another vehicle or navigating a road having a steep turning radius. In a further embodiment, the one or more local paths may meet the global path such that the AV continues to navigate along the global path after at least one of avoiding obstacles, changing lanes, overtaking another vehicle or navigating a road having a steep turning radius.

In an embodiment, the one or more sensors (103) may include, but are not limited to, a Light Ranging and Detection (LIDAR) system, an ultrasound sensor, a camera, a proximity sensor, a compass and the like.

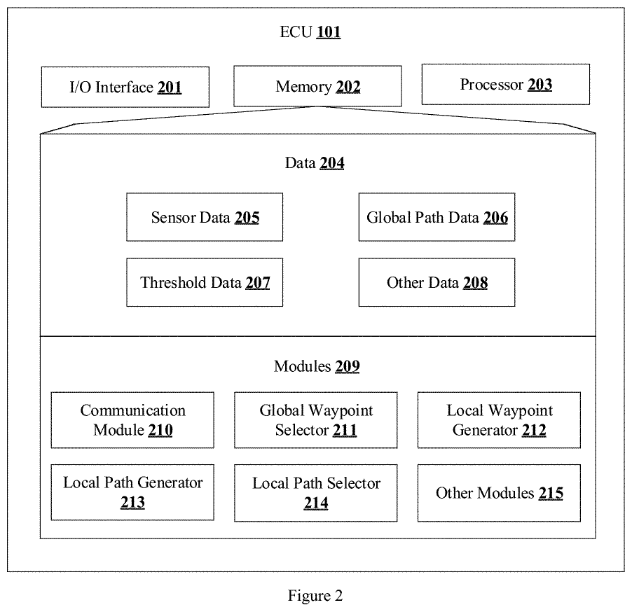

FIG. 2 illustrates internal architecture of the ECU (101) in accordance with some embodiments of the present disclosure. The ECU (101) may include at least one Central Processing Unit (“CPU” or “processor”) (203) and a memory (202) storing instructions executable by the at least one processor (203). The processor (203) may comprise at least one data processor for executing program components for executing user or system-generated requests. The memory (202) is communicatively coupled to the processor (203). The ECU (101) further comprises an Input/Output (I/O) interface (201). The I/O interface (201) is coupled with the processor (203) through which an input signal or/and an output signal is communicated.

In an embodiment, data (204) may be stored within the memory (202). The data (204) may include, for example, sensor data (205), global path data (206), threshold data (207), and other data (208).

In an embodiment, the sensor data (205) may include information on obstacles present in the global path. The one or more sensors (103) may detect any obstacles in the global path and provides information regarding the obstacles to the ECU (101). For example, the one or more sensors (103) may detect a wall or a divider as an obstacle. In another embodiment, the one or more sensors (103) may detect a person or another vehicle as an obstacle. The sensor data (205) may also include orientation information of the AV. The compass may be used to determine the orientation of the vehicle. The orientation of the AV may be calculated from an orientation of the global path. For example, the orientation of the global path can be taken as reference, and an angle deviation of the AV from the global path may be used to calculate the orientation of the AV.

In an embodiment, the global path data (206) may include but not limited to a source location, a destination location, a plurality of global waypoints, an orientation of each global waypoint and a separation distance between the plurality of global waypoints.

In an embodiment, the threshold data (207) may include an AV orientation threshold, a proximity value, and local path orientation threshold. In an embodiment, the AV orientation threshold may indicate an orientation boundary of the orientation of the AV with respect to the orientation of the global path. If the orientation of the AV is beyond the orientation threshold, then the ECU (101) may be configured to generate the one or more sets of local paths. In an embodiment, the proximity value may indicate a distance between the one or more sets of local paths and the global path. The one or more sets of local paths may be generated proximate to the global path. Each local path is comprises multiple consecutive ‘arc distance’ which is considered as radius of different size circle. The proximity value may indicate a threshold measure of how much proximate the one or more sets of local paths from the global path. In an embodiment, the local path orientation threshold may indicate an orientation boundary of orientation of the one or more sets of local paths from the orientation of the global path.

In an embodiment, the other data (208) may include but is not limited to traffic information, terrain information, and the like.

In an embodiment, the data (204) in the memory (202) is processed by modules (209) of the ECU (101). As used herein, the term module refers to an

Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. The modules (209) when configured with the functionality defined in the present disclosure will result in a novel hardware.

In one implementation, the modules (209) may include, for example, a communication module (210), a global waypoint selector (211), a local waypoint generator (212), a local path generator (213), a local path selector (214) and other modules (215). It will be appreciated that such aforementioned modules (209) may be represented as a single module or a combination of different modules.

The communication module (210) may facilitate communication between the ECU (101) and other units (not shown in figures) of the AV. In an embodiment, the other units may comprise, but are not limited to, a transmission control unit, a door unit, a steering controller, an indication unit, and the like. For example, the communication module (210) may receive the global path data (206) from the main controller (102) and the sensor data (205) from the one or more sensors (103). Also, the communication module (210) may provide instructions to the main controller (102). Also, the communication module (210) may communicate instructions to the one or more sensors (103) regarding activation and deactivation of the one or more sensors (103). In an embodiment, the global path may comprise a plurality of global waypoints. The plurality of global waypoints may be intermediate points on the global path. Each global waypoint has an orientation (direction). Connecting the plurality of global waypoints may generate the global path. In an embodiment, the communication module (210) may receive the global path data (206) when the orientation of the AV deviates beyond the AV orientation threshold.

In an embodiment, the global waypoint selector (211) may receive the global path data (206) from the communication module. The global waypoint selector (211) may also receive current location of the AV either from the main controller (102) or from the one or more sensors (103). Further, the global waypoint selector (211) may randomly select one or more global waypoints from the plurality of global waypoints on the global path. In an embodiment, the global waypoint selector (211) may select the one or more global waypoints ahead of the AV, such that one or more sets of local paths are generated from each of the one or more global waypoints.

In an embodiment, the local waypoint generator (212) may be configured to generate the one or more sets of local waypoints for each of the selected one or more global waypoints. The one or more sets of local waypoints are generated to navigate the AV smoothly during at least one of avoiding obstacles, changing lanes overtaking other vehicles or maneuvering a steep turn. The one or more sets of the local paths are one or more short paths proximate or closer to the global path. In an embodiment, the local waypoint generator (212) may be configured to generate a first set of local waypoints and thereafter generate a second set of local waypoints for each of the first set of local waypoint. In a further embodiment, the third set of local waypoints may be generated to adjust an alignment/orientation of the local path by connecting the selected local waypoint, became adaptively aligned to the base global path within some distance. In an embodiment, ‘N” sets of local waypoints can be generated for adjusting the orientation of the AV when the AV navigates using the “N” sets of local waypoints.

In an embodiment, the local path generator (213) is configured to generate one or more local paths. The one or more local paths are generated by connecting the one or more sets of local waypoints. In one embodiment, the first set of local paths are generated from the location of the AV to the first set of local waypoints. Thereafter, a second set of local paths are generated from the first set of local waypoints to the second set of local waypoints. Likewise, “N” local paths may be generated when “N” sets of local waypoints are generated. The one or more local paths are generated such that the one or more local paths are proximate to the global paths, i.e., the one or more local paths are at a maximum distance equal to the proximity value, from the global path.

In an embodiment, the local path selector (214) may be configured to select a local path from the one or more local paths. In an embodiment, the local path is selected from the one or more local paths based on a cost factor. The cost factor may include, but not limited to at least a proximity/distance of the one or more local paths from the global path, estimated energy consumed navigating the one or more local paths and steering angle of the AV navigating the one or more local paths. In one embodiment, when the one or more local paths has a curvature, a farthest point on the one or more local paths may be at distance equal to the proximity value, from the global path. For example, consider two local paths, a first and a second local path. Let a farthest point on the first local path be at a distance equal to 3 meters and a farthest point on the second local path be at a distance equal to 2.5 meters. The local path selector (214) selects the second local path as the distance/proximity value of the second local path is smaller than the distance/proximity value of the first local path. In one embodiment, the local path selector (214) may select the local path based on the orientation of the first local path and the second local path. For example, consider that the first local path has an orientation beyond the orientation threshold. In such scenario, the local path selector (214) selects the second local path.

In an embodiment, the other modules (215) may include but is not limited to a notification module to indicate when the vehicle is moving in the local path.

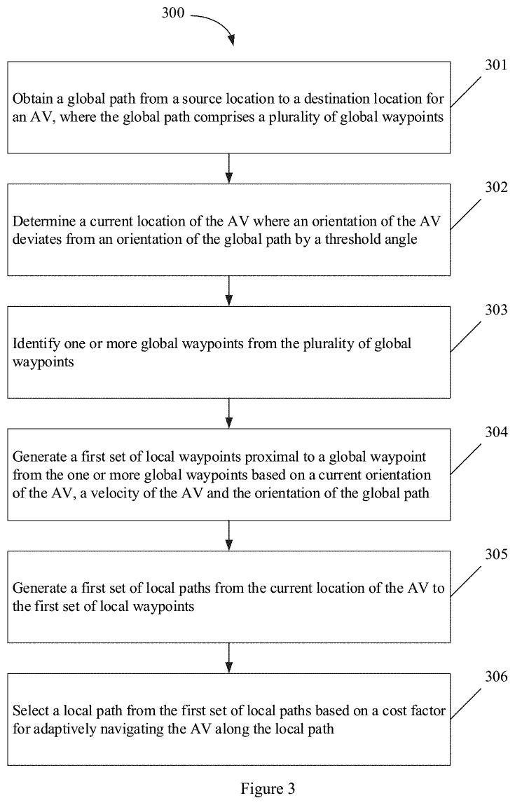

FIG. 3 is a flowchart illustrating method steps for adaptively navigating the AV.

As illustrated in FIG. 3, the method (300) may comprise one or more steps. The method (300) may be described in the general context of computer executable instructions. Generally, computer executable instructions can include routines, programs, objects, components, data structures, procedures, modules, and functions, which perform particular functions or implement particular abstract data types.

The order in which the method (300) is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

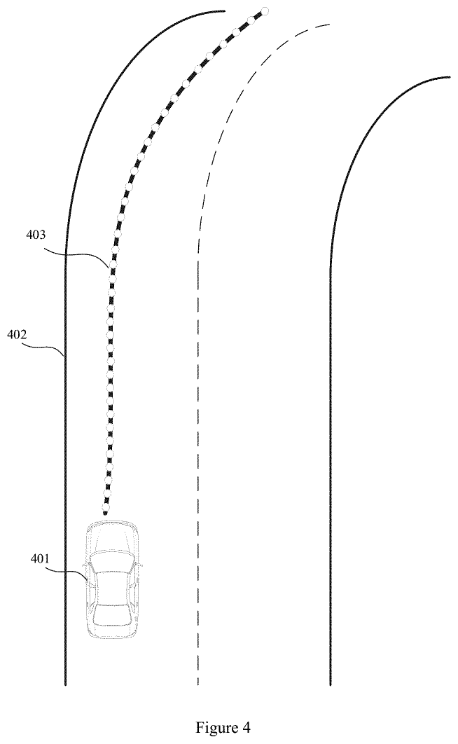

At step (301), obtaining by the communication module (210), the global path from the main controller (102). The global path comprising the plurality of global waypoints are obtained from the main controller (102). Reference is now made to FIG. 4 showing an exemplary illustration of an AV (401) navigating along the road (402). The global path (403) is generated for the AV (401) to navigate the road (402). In some embodiments the global path (403) may be generated according to a lane present in the road (402). In some embodiments, the global path (403) may not consider a lane present in the road (402). In an embodiment, where the global path (403) does not consider the lane, the AV (401) may have to use the one or more sensors (103) to identify the lane in the road (402) and follow the global path (403) in the identified lane. In an embodiment, the global path (403) may be generated my modules (such as a path planning module) of the main controller (102). In a further embodiment, the global path (403) may be generated using techniques including but not limited to, Dijkstra, A*, and the like.

Referring back to FIG. 3, at step (302), determining by the global waypoint selector (211), a location of the AV (401) where the orientation of the AV (401) has deviated from the orientation of the global path (403). In an embodiment, the global waypoint selector (211) may receive AV orientation data and location data from the one or more sensors (103) at defined intervals. The global waypoint selector (211) may determine if the orientation of the AV (401) has deviated beyond the AV orientation threshold. When the global waypoint selector (211) determines the deviation in the AV orientation, the global waypoint selector (211) correlates the AV location to such AV orientation deviation.

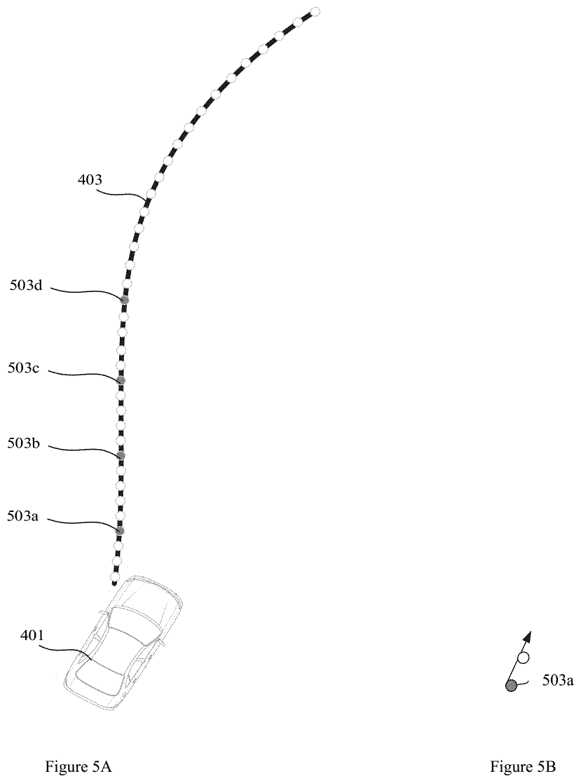

At step (303), identifying by the global waypoint selector (211) one or more global waypoints from the plurality of global waypoints. Once the global waypoint selector (211) determines the location of the AV (401), one or more global waypoints on the global path (403) are identified. The one or more global waypoints are identified such that the one or more global waypoints are ahead of the AV (401) on the global path (403). Referring to FIG. 5A, an exemplary illustration of selecting the one or more global waypoints is shown. As shown, the one or more global waypoints are colored (503a, 503b, 503c, 503d). For each of the one or more global waypoints (503a, 503b, 503c, 503d), one or more sets of local waypoints needs to be generated. In an embodiment, the one or more global waypoints (503a, 503b, 503c, 503d) are selected when the orientation of the AV (401) is deviating from the orientation of the global path (403). For example, when the orientation of the AV (401) is deviated from the orientation of the global path (403) while maneuvering an obstacle, the one or more global waypoints (503a, 503b, 503c, 503d) are calculated. In one embodiment, number of the one or more global waypoints may be randomly selected maintaining a threshold separation distance. In one embodiment, the global waypoint selector (211) may determine if the selected one or more global waypoints (503a, 503b, 503c, 503d) can be reached by the AV (401) via one or more local paths within a steering angle, distance & orientation threshold.

FIG. 5B is an exemplary illustration of determining the orientation of the global waypoints (503a, 503b, 503c, 503d) in a global path (403). In an embodiment, the one or more global waypoints (503a, 503b, 503c, 503d) may be vectors having a direction. As illustrated in FIG. 5B, the orientation of the global waypoint (503a) is determined. The global waypoint (503a) and the subsequent global waypoint are considered. The arrow connecting the global waypoint (503a) with the subsequent global waypoint may indicate a direction/orientation of the global waypoint (503a). Likewise, the direction/orientation of the one or more global waypoints (503a, 503b, 503c, 503d) in the global path (403) are determined.

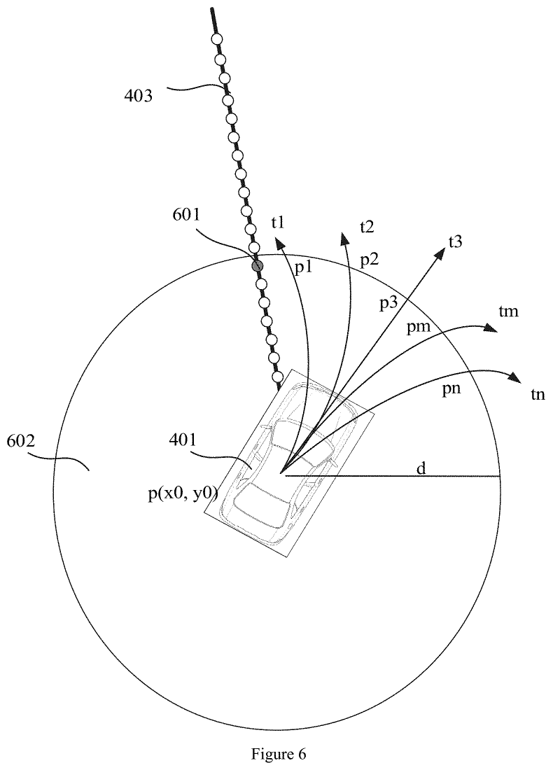

Referring back to FIG. 3, at step (304), generating by the local waypoint generator (212), one or more sets of local waypoints proximal to a global waypoint from the one or more global waypoints based on a current orientation of the AV (401), a velocity of the AV (401) and the orientation of the global path (403). Referring to FIG. 6, the local waypoint generator (212) generates a first set of local waypoints at a global waypoint (601). The technique as illustrated in FIG. 6 may be used for generating a first set of local waypoints for each of the one or more global waypoints. As shown in FIG. 6, the global waypoint (601) from the one or more global waypoints is selected for generating the first set of local waypoints. The first set of local waypoints may be generated on a circle (602) having a radius equal to a distance (d) between the AV (401) and the global waypoint (601) and the AV (401) at the center of the circle (602). A position of the AV (401) may be p(x0, y0). In an embodiment, the first set of local waypoints may comprise a plurality of local waypoints. At least one local waypoint which is reachable by the AV (401) is selected. The reachability of the AV (401) to the at least one local waypoint may be determined based on at least a steering angle of the AV (401) and the distance (d). The following description describes the generation of the first set of local waypoints. In FIG. 6, a plurality of trajectories (t1, t2, . . . , tm, tn) are generated from the AV (401). A point on each of the plurality of trajectories (t1, t2, . . . , tm, tn) is selected such that distance between the AV (401) and the point on each of the plurality of trajectories (t1, t2, . . . , tm, tn) is equal to the distance (d) and the steering angle of the AV is less than a threshold steering angle. Such points on the trajectories (t1, t2, tm, tn) may be considered as first set of local waypoints (p1, p2, . . . , pm, pn). Let (r1, r2, . . . rm, rn) be the orientation of the plurality of local waypoint (p1, p2, . . . , pm, pn). Let us consider that for the trajectory (t2), the selected point on the trajectory is (p2). Let position of pm be represented as p2(x1, y1). A distance between the AV (401) and the local waypoint (pm) may be calculated using the equation 1:

d=sqrt((x1−x0)²+(y1−y0)²) (1)

The circle (602) is determined, where the circle has a radius equal to the distance (d). Further, each point on the circumference of the circle (602) where the trajectories (t1, t2, . . . , tm, tn) meet the circle (602) may be a local waypoint. As seen in FIG. 6, the first set of local waypoints (p1, p2, . . . , pm, pn) fall on the circumference of the circle (602). In an embodiment, the first set of local waypoints (p1, p2, . . . , pm, pn) may be determined by incrementing the values of x and y from the local waypoint p2(x1, y1). For example, by incrementing Δx and Δy from the local waypoint p2(x1, y1), the local waypoint (p3) can be obtained having a position p3(x1+Δx, y1+Δy). Likewise, different local waypoints can be obtained by incrementing/decrementing Δx and Δy from a reference local waypoint. Further, an orientation for each local waypoint is calculated based on a polynomial path equation parameters. The below Table 1 shows the local waypoints and corresponding orientation and position:

TABLE 1

| Waypoints | Orientation | Position |
|---|---|---|
| p1 | r1 | x1, y1 |
| p2 | r2 | x2, y2 |
| p3 | r3 | x3, y3 |
| . . . | . . . | . . . |
| pm | rm | xm, ym |
| pn | rn | xn, yn |

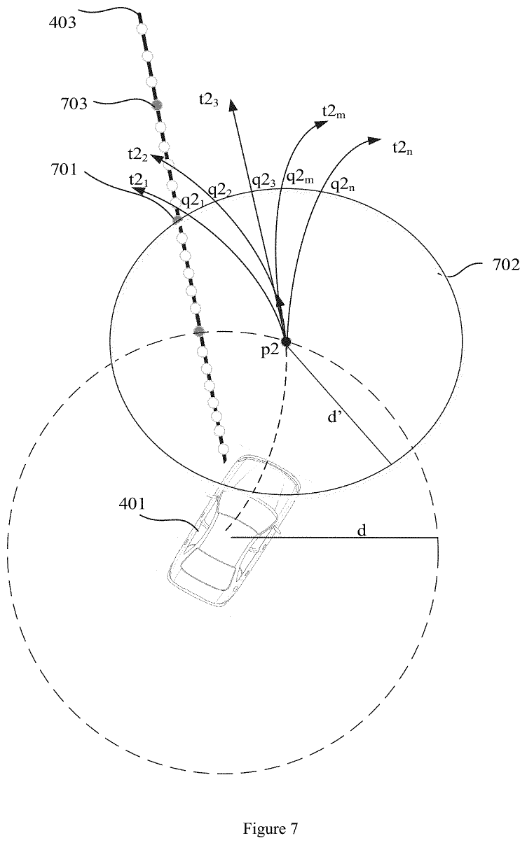

Reference is now made to FIG. 7 which illustrates adjustment of local waypoints, in accordance with some embodiments of the present disclosure. As shown in FIG. 7, a second set of local waypoints may be generated to adjust the first set of waypoints (p1, p2, . . . , pm, pn). Considering the local waypoint (p2) was in the first set of local waypoints (p1, p2, . . . , pm, pn), the orientation of the local waypoint (p2) may be deviating from the global path (403), however, within local waypoint orientation threshold. Let the global waypoint (701) be selected to adjust the local waypoint (pm). A second set of local waypoints (q1, q1₂, q2₁, q2₂, . . . , qm₁, qm₂, . . . , qn₁, qnₙ) may be generated by generating a plurality of trajectories (t1, t1₂, . . . , t2₁, t2₂, . . . , tm₁, tm₂, . . . , tn₁, 1nₙ). A circle (702) may be determined having a radius equal to a distance between the local waypoint (p2) and the global waypoint (701). In an embodiment, the second set of local waypoints (q1, q1₂, . . . , q2₁, q2₂, . . . , qm₁, qm₂, . . . , qn₁, qnₙ) may be generated when the first set of local waypoints (p1, p2, . . . , pm, pn) are not proximate/closer to the global path (403). In an embodiment, the second set of local waypoints (q1, q1₂, . . . , q2₁, q2₂, . . . , qm₁, qm₂, . . . , qn₁, qnₙ) may be generated for the vehicle (401) to meet the global waypoint (703).

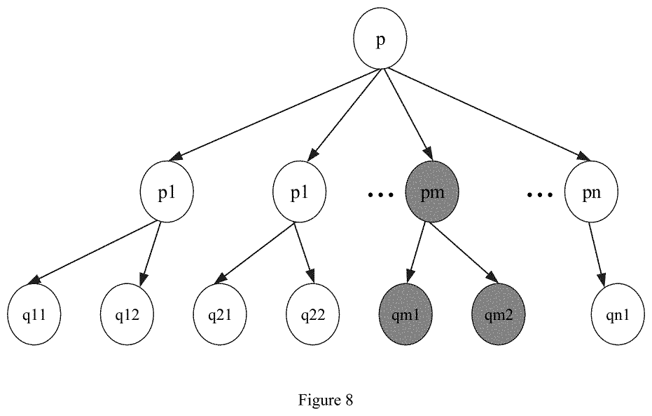

FIG. 8 shows a tree structure for generating a plurality of sets of local waypoints. As shown, a first local set of local waypoints (p1, p2, . . . , pm, . . . , pn) may be generated for the AV (401) to join the global path (403). Subsequent sets of local waypoints (q11, q12, . . . , q1n, q21, q22, . . . q2n, qm1, qm2, . . . , qmn, qn1, qn2, . . . , qnn) may be generated to correct path of the AV (401) generated using the first set of local waypoints (p1, p2, . . . , pm, . . . , pn). In one embodiment, for each of the first set of local waypoint, a plurality of second set of waypoints may be generated. Likewise, for each of the second set of local waypoint, a plurality of third set of waypoints may be generated, and so on. As illustrated, the selected waypoints are indicated as colored nodes in FIG. 8.

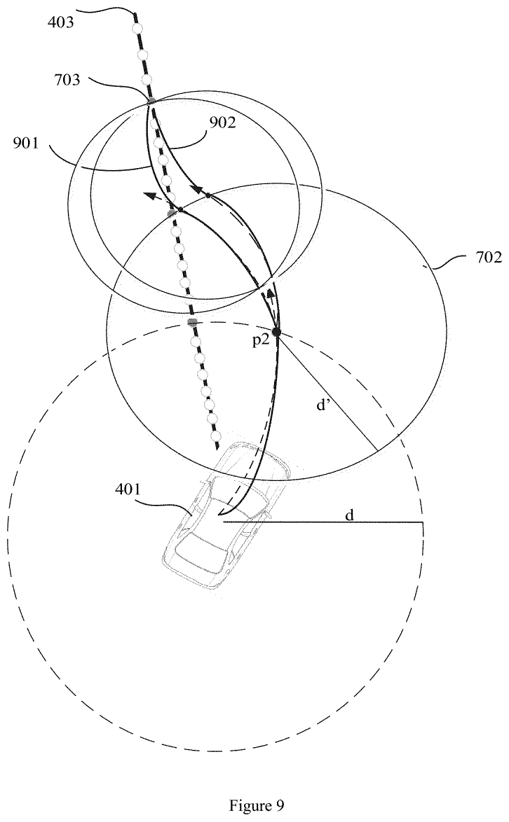

Referring back to FIG. 3, at step (305), generating by the local path generator (213), one or more sets of local paths. In one embodiment, when the first set of local waypoints (p1, p2, . . . , pm, pn) are generated, the local path generator (213) generates a first set of local paths connecting the AV (401) and the first set of local waypoints (p1, p2, . . . , pm, pn). In an embodiment, when the first (p1, p2, . . . , pm, pn) and second (q1, q1₂, . . . , q2₁, q2₂, . . . , qm₁, qm₂, . . . , qn₁, qnₙ) set of waypoints are generated, the local path generator (213) may be configured to generate the first set of local paths and a second set of local paths. In an embodiment, the first set of local paths may be connected between the AV (401) and the first set of local waypoints (p1, p2, . . . , pm, pn) and the second set of local paths may be connected between the first set of local waypoints (p1, p2, . . . , pm, pn) and the second set of local waypoints (q1, q1₂, . . . , q2₁, q2₂, . . . , qm₁, qm₂, . . . , qn₁, qnₙ). In a further embodiment, a third set of local waypoints (not shown) may be generated to correct the direction of the second set of local waypoints (q1, q1₂, . . . , q2₁, q2₂, . . . , qm₁, qm₂, . . . , qn₁, qnₙ). In the exemplified embodiment of FIG. 9, the third set of local waypoints may be generated for the second local waypoint (q2₁) and (q2₂). In an embodiment, n sets of local waypoints may be generated such that the AV (401) navigates towards the global path (403) to meet he global waypoint (703). FIG. 9 shows an exemplary illustration of local paths (901, 902). As show, each path may have different curvature and may meet the global path (403) at different points. As shown, the local path (901) traverses the local waypoints (p2, q2₁), and the local path (902) traverse the local waypoints (p2, q2₂).

Local path (901): p2→q2₁

Local path (902): p2→q2₂

In an embodiment, trajectory corrections may be made to the local path (901) and the local path (902) such that the one or more local paths (901 and 902) meet the global path at the global waypoint (703). As shown in FIG. 9, for the local path (901), the trajectory correction is made at the third local waypoint (q2₁) to meet the global path (403). Likewise, for the for the local path (902), the trajectory correction is made at the third local waypoint (q2₂) to meet the global path (403). In one embodiment, trajectory corrections may be performed by way of small adjustments in the path. In a further embodiment, the trajectory corrections by way of small adjustments is performed when the local waypoint is close to the global path (403) and/or having the orientation in the direction of the global path (403) to meet the global waypoint (703). In one embodiment, trajectory corrections may be performed by generating subsequent sets of local waypoints. In a further embodiment, the trajectory corrections by way of generating subsequent sets of local waypoints is performed when the previous local waypoint is far from the global path (403) and/or having the orientation away from the direction of the global path (403).

At step (306), selecting by the local path selector (214), a local path from the one or more local paths (901, 902) based on a cost factor. The cost factor may include, but not limited to at least a proximity/distance of the one or more local paths from the global path (403), estimated energy consumed navigating the one or more local paths and steering angle of the AV navigating the one or more local paths. In one embodiment, when the one or more local paths has a curvature, a farthest point on the one or more local paths may be at distance equal to the proximity value, from the global path (403). For example, consider two local paths, a first (901) and a second local path (901). The local paths (901, 902) are generated from the first waypoint (p2). Let a farthest point on the first local path (901) be at a distance equal to 2.5 meters and a farthest point on the second local path (902) be at a distance equal to 3 meters. The second local path selector (214) selects the first local path (901) as the distance/proximity value of the first local path (901) is smaller than the distance/proximity value of the second local path (902). Further to the above example, consider an orientation of the second local path (902) is towards the global path (403) and an orientation of the first local path (901) has an orientation deviating from the global path (403). In such scenario, although the second local path (902) may have greater distance to meet the global path (403) compared to the first local path (901), the local path selector (214) selects the second local path (902) for navigating the AV (401) as the first local path (901) is orientated towards the global path (403). In one embodiment, the local path is selected such that energy consumption of the AV (401) minimum. In one embodiment, the energy consumption is minimum when at least one of the distance to be traversed by the AV (401) via the one or more local paths is less and the orientation of the one or more local paths is towards the global path (403) and is within the orientation threshold.

In an embodiment, the present disclosure provides a method and a system for generating improvised local paths which enables smooth navigation of the AV (401).

In an embodiment, the present disclosure provides a method and a system for generating effective local paths that results in less energy consumption for the AV (401).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method for adaptive navigation of an Autonomous Vehicle (AV), the method comprising:
obtaining, by an autonomous navigation system, a global path from a source location to a destination location for the AV, wherein the global path comprises a plurality of global waypoints;
determining, by the autonomous navigation system, a current location of the AV where an orientation of the AV is deviating from an orientation of the global path by a threshold angle;
identifying, by the autonomous navigation system, one or more global waypoints from the plurality of global waypoints;
generating, by the autonomous navigation system, a first set of local waypoints proximal to a global waypoint from the one or more global waypoints based on the current orientation of the AV, a velocity of the AV and the orientation of the global path;
generating, by the autonomous navigation system, a first set of local paths from the current location of the AV to the first set of local waypoints, wherein the AV is configured to navigate along the first set of local paths proximate to the global path; and
selecting, by the autonomous navigation system, a local path from the first set of local paths based on a cost factor, for adaptively navigating the AV along the local path.

2. The method of claim 1 further comprises:
generating a second set of local waypoints subsequent to the each of the first set of local waypoints; and
generating a second set of local paths from the first set of local waypoints to the second set of local waypoints proximate to the global path, wherein the second set of local waypoints are generated for adjusting a trajectory of the AV proximate to the global path.

3. The method of claim 1, wherein the first set of local paths have an orientation towards the global path and is proximate to the global waypoint, wherein one or more alternate sets of local waypoints are generated upon one or more of the first set of local paths are not proximate to the global path and the orientation of the first set of local paths deviates from the orientation of the global path by the threshold angle, wherein the first set of local paths is generated by fitting a polynomial parametric curve.

4. The method of claim 1, wherein a distance between the first set of local waypoints from the current location of the AV is equal to a distance between the global waypoint and the current location of the AV, wherein the first set of local waypoints are generated around the current location of the AV, wherein a position of the first set of local waypoints is determined using the distance and an orientation of the first set of local paths generated from the current location of the AV to the first set of local waypoints.

5. The method of claim 1, wherein the selecting the local path further comprises:
determining an orientation of each local path in the first set of local paths;
comparing the orientation of each local path in the first set of local paths with the orientation of the global path; and
selecting the local path having the orientation below the threshold angle and based on the cost factor comprising at least one of at least a distance of the first set of local paths and a steering angle of the AV.

6. An autonomous navigation system for adaptive navigating an Autonomous Vehicle (AV), comprising:
one or more processors; and
one or more memories, communicatively coupled to the one or more processors, storing processor executable instructions, which on execution causes the one or more processors to:
obtain a global path from a source location to a destination location for the AV, wherein the global path comprises a plurality of global waypoints;
determine a current location of the AV where an orientation of the AV is deviating from an orientation of the global path by a threshold angle;
identify one or more global waypoints from the plurality of global waypoints;
generate a first set of local waypoints proximal to a global waypoint from the one or more global waypoints based on the current orientation of the AV, a velocity of the AV and the orientation of the global path;
generate a first set of local paths from the current location of the AV to the first set of local waypoints, wherein the AV is configured to navigate along the first set of local paths proximate to the global path; and
select a local path from the first set of local paths based on a cost factor, for adaptively navigating the AV along the local path.

7. The autonomous navigation system of claim 6, wherein the one or more processors are configured to:
generate a second set of local waypoints subsequent to the each of the first set of local waypoints; and
generate a second set of local paths from the first set of local waypoints to the second set of local waypoints proximate to the global path, wherein the one or more processors generate the second set of local waypoints for adjusting a trajectory of the AV proximate to the global path.

8. The autonomous navigation system of claim 6, wherein the one or more processors generate the first set of local paths having an orientation towards the global path and is proximate to the global waypoint, wherein the one or more processors are configured to generate one or more alternate sets of local waypoints when one or more of the first set of local paths are not proximate to the global path and the orientation of the first set of local paths deviates from the orientation of the global path by the threshold angle.

9. The autonomous navigation system of claim 6, wherein the one or more processors determine a position of the first set of local waypoints using a distance between the AV and the global point and an orientation of the first set of local paths generated from the current location of the AV to the first set of local waypoints.

10. The autonomous navigation system of claim 6, wherein the one or more processors are configured to select the local path, wherein the one or more processors:
determine an orientation of each local path in the first set of local paths;
compare the orientation of each local path in the first set of local paths with the orientation of the global path; and
select the local path having the orientation below the threshold angle.

11. A non-transitory computer readable medium including instructions stored thereon that when processed by at least one processor cause a device to perform operations comprising:
obtaining a global path from a source location to a destination location for the AV, wherein the global path comprises a plurality of global waypoints;
determining a current location of the AV where an orientation of the AV is deviating from an orientation of the global path by a threshold angle;
identifying one or more global waypoints from the plurality of global waypoints;
generating a first set of local waypoints proximal to a global waypoint from the one or more global waypoints based on the current orientation of the AV, a velocity of the AV and the orientation of the global path;
generating a first set of local paths from the current location of the AV to the first set of local waypoints, wherein the AV is configured to navigate along the first set of local paths proximate to the global path; and
selecting, by the autonomous navigation system, a local path from the first set of local paths based on a cost factor, for adaptively navigating the AV along the local path.

12. The non-transitory computer readable medium of claim 11, further comprises:
generating a second set of local waypoints subsequent to the each of the first set of local waypoints; and
generating a second set of local paths from the first set of local waypoints to the second set of local waypoints proximate to the global path, wherein the second set of local waypoints are generated for adjusting a trajectory of the AV proximate to the global path.

13. The non-transitory computer readable medium of claim 11, wherein the first set of local paths have an orientation towards the global path and is proximate to the global waypoint, wherein one or more alternate sets of local waypoints are generated upon one or more of the first set of local paths are not proximate to the global path and the orientation of the first set of local paths deviates from the orientation of the global path by the threshold angle, wherein the first set of local paths is generated by fitting a polynomial parametric curve.

14. The non-transitory computer readable medium of claim 11, wherein a distance between the first set of local waypoints from the current location of the AV is equal to a distance between the global waypoint and the current location of the AV, wherein the first set of local waypoints are generated around the current location of the AV, wherein a position of the first set of local waypoints is determined using the distance and an orientation of the first set of local paths generated from the current location of the AV to the first set of local waypoints.
